(19) United States
(12) Patent Application Publication
(10) Pub. No.: US 2019/0141511 A1
(43) Pub. Date: May 9, 2019

(54) DETECTION AND COMMUNICATION SYSTEM FOR MOBILE DEVICES

(71) Applicant: RDI SAS, Caen (FR)

(72) Inventors: Samy BENHELLAL, Cormelles Le Royal (FR); Malek REZGUI, Bieville Beuville (FR)

(73) Assignee: RDI SAS, Caen (FR)

(21) Appl. No.: 16/096,844

(22) PCT Filed: Apr. 29, 2016
(86) PCT No.: PCT/FR2016/051017

§ 371 Date: Oct. 26, 2018

(51) Int. Cl. H04W 8/00; H04B 1/00; H04W 4/80; H04W 88/06

(52) U.S. Cl. CPC H04W 8/005; H04W 88/06; H04W 4/80; H04B 1/0067

(57) ABSTRACT

A detection and communication system for mobile devices, the system comprising at least two mobile devices (D1, D2) of the mobile telephone, tablet, connected smartwatch, or similar type, each mobile device being fitted with long-range communication means of the Wi-Fi type and with short-range communication means of the Bluetooth® type, said system including an identification platform enabling users to identify their mobile devices, said system being characterized in that it detects all mobile devices identified on said identification platform and that come within the fields of said long-range and/or short-range communication means, and in that, in the absence of a telephone communication network, in particular of the 2G, 3G, 4G, 5G, UMTS, GPRS, or EDGE type, said long-range communication means push the signals of said short-range communication means so that two identified mobile devices within the fields of said long-range communication means can communicate via their short-range communication means, even beyond the range of said short-range communication means.

The present invention relates to a detection and communication system for mobile devices.

In conventional manner, mobile devices, such as mobile telephones, tablets, connected smartwatches, or the like, can be detected and can communicate remotely either via the telephone network, in particular comprising second-generation (2G), 3G, 4G, 5G, general packet radio service (GPRS), enhanced data rates for GSM evolution (EDGE), universal mobile telecommunications system (UMTS), etc. antennas, or else via long-range wireless communications protocols, in particular of the Wi-Fi type, or via short-range protocols, in particular of the Bluetooth® type. Typically, the range of Wi-Fi type networks is of the order of a few hundreds of meters, while the range of Bluetooth® type networks is of the order of a few tens of meters. Social networks, such as Facebook® or the like, include identification platforms that enable users to identify themselves and thus to communicate with other users identified in like manner. This communication makes use either of telephone networks, or of Wi-Fi type networks. In order to detect mobile devices, global positioning system (GPS) signals are generally used. In the absence of telephone networks, and in the absence of GPS signals, only Wi-Fi and Bluetooth® type networks are thus available. This can give rise to problems of communication between mobile devices, and can make it impossible to detect mobile devices, typically when they are in closed premises underground, such as in bars or discotheques, or in stadiums or performance venues.

An object of the present invention is to provide a detection and communication system for mobile devices that does not reproduce the drawbacks of existing systems.

An object of the present invention is also to provide a detection and communication system for mobile devices that enables mobile devices to communicate, even in the absence of a telephone network.

An object of the present invention is also to provide a detection and communication system for mobile devices that enables mobile devices to be detected even in the absence of a telephone network and/or a GPS signal.

An object of the present invention is also to provide a detection and communication system for mobile devices that is simple and inexpensive to implement and to use.

The present invention thus provides a detection and communication system for mobile devices, the system comprising at least two mobile devices of the mobile telephone, tablet, connected smartwatch, or similar type, each mobile device being equipped with long-range communication means of the Wi-Fi type and with short-range communication means of the Bluetooth® type, said system including an identification platform enabling users to identify their mobile devices, said system being characterized in that it detects all mobile devices identified on said identification platform and that come within the fields of said long-range and/or short-range communication means, and in that, in the absence of a telephone communication network, in particular of the 2G, 3G, 4G, 5G, UMTS, GPRS, or EDGE type, said long-range communication means push the signals of said short-range communication means so that two identified mobile devices within the fields of said long-range communication means can communicate via their short-range communication means, even beyond the range of said short-range communication means.

Advantageously, said identification platform is connected to at least one social network of the Facebook® type.

Advantageously, the Bluetooth is of type 1, 2, 3, or 4, in particular at the frequency of 2.4 gigahertz (GHz).

Advantageously, the Wi-Fi is based on the 802.11 standard at a frequency of 2.4 GHz to 5 GHz, and in particular in any of the A, B, G, N, AC, AD, AH forms.

Advantageously, Bluetooth® and Wi-Fi are added together for each mobile device, thereby creating an antenna specific to each mobile device.

Advantageously, the data transfer rate between mobile devices in communication is of the order of 10 kilobits per second (kbps) to 20 kbps, typically about 15 kbps.

Advantageously, the system includes a mobile application installed on each mobile device.

These characteristics and advantages, and others, appear more clearly from the following detailed description made with reference to the accompanying drawings given as non-limiting examples, and in which:

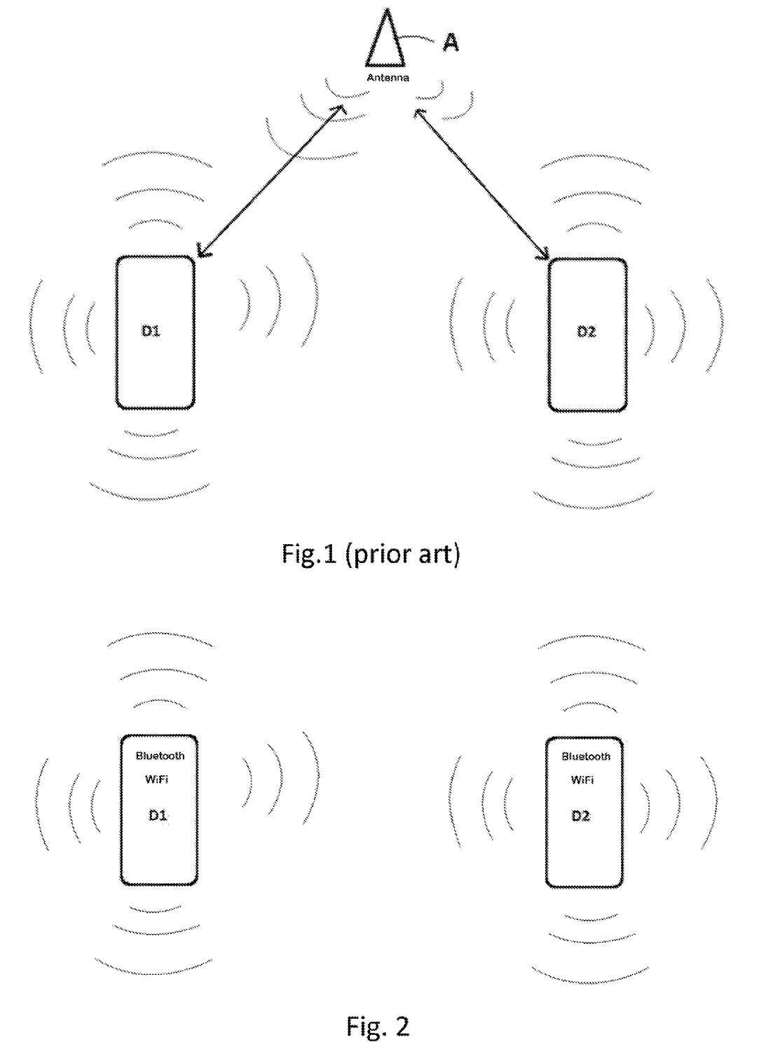

FIG. 1 is a simplified theoretical diagram showing the operation of a communication system using the telephone network;

FIG. 2 is a similar diagram showing two mobile devices without access to the telephone network;

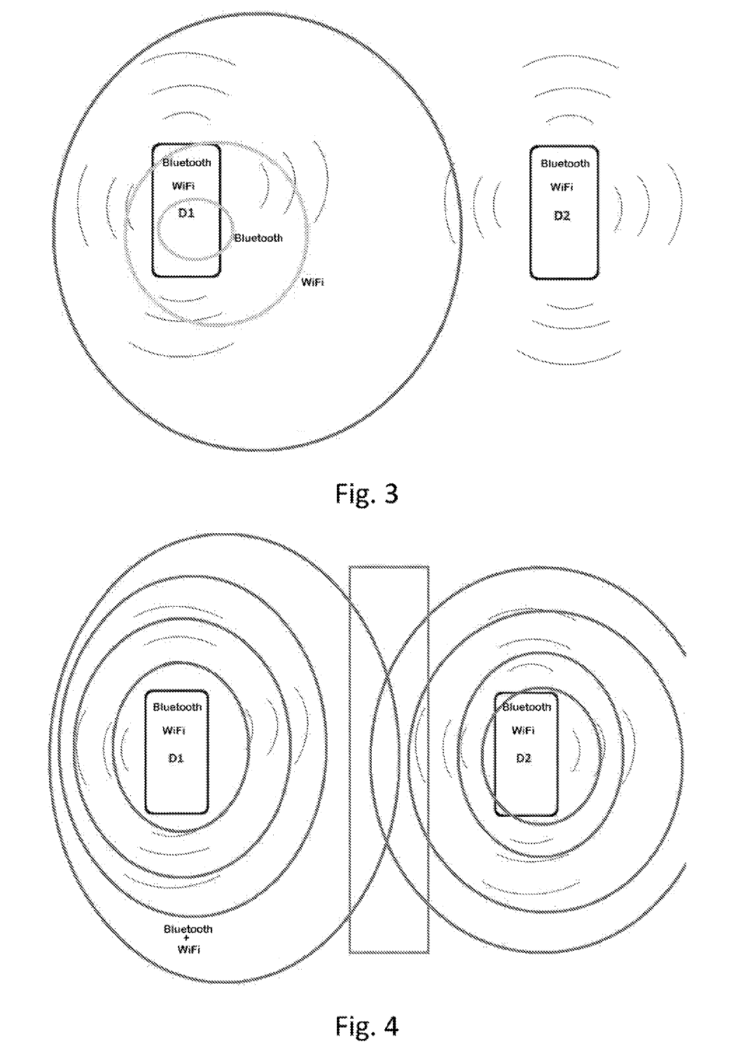

FIG. 3 is a diagram showing a mobile device being detected with a detection and communication system for mobile devices in an advantageous embodiment of the present invention; and

FIG. 4 is a diagram showing communication between two mobile devices with a communication system for mobile devices in an advantageous embodiment of the present invention.

FIG. 1 shows the conventional operation of two mobile devices (or peripherals) connected to the same antenna A of a telephone network. This antenna A may conventionally be a 2G, 3G, 4G, 5G, UMTS, GPRS, EDGE, etc. antenna. Naturally, an arbitrary number of mobile devices may be connected simultaneously. In transmission, the antenna pushes out a signal so as to enable the mobile devices to become attached to the antenna.

Thus, the mobile devices D1 and D2 need the antenna A to pick up the same frequency and thus to communicate.

FIG. 2 shows two mobile devices that are not connected to a telephone network. Both mobile devices include long-range communication means of the Wi-Fi type, and short-range communication means, of the Bluetooth® type.

In particular, the Bluetooth® may be of type 1, 2, 3, or 4 (in particular at the frequency of 2.4 GHz), and the Wi-Fi may be based on the 802.11 standard (at a frequency of 2.4 to 5 GHz) and in particular in any of the forms A, B, G, N, AC, AD, or AH.

The system includes an identification platform enabling users to identify their mobile devices. Advantageously, the identification platform is based on existing social networks, such as for example Facebook®, LinkedIn®, Viadeo®, or the like. The user can thus be identified on the identification platform, e.g. using a Facebook® account. This simplifies connection and identification.

According to the invention, said system detects all of the mobile devices identified on said identification platform and that come within its Wi-Fi and/or Bluetooth® fields. This detection does not require a telephone network, nor does it require a GPS signal.

If a telephone network is available, in particular of the 2G, 3G, 4G, 5G, UMTS, GPRS, EDGE type, each mobile device can communicate via said telephone network with one or more of the detected mobile devices.

In the absence of such a telephone communication network, Wi-Fi pushes Bluetooth® signals, such that two identified mobile devices within the Wi-Fi field can communicate via Bluetooth®, even beyond the range of said Bluetooth®.

The present invention makes it possible to add together the Bluetooth® and Wi-Fi antennas for each mobile device, thereby creating one antenna specific to each mobile device.

Thus, mobile devices using the system of the invention can make use of their own signaling and communication antennas that are detectable by each identified mobile device located in the Wi-Fi and/or Bluetooth® fields.

Advantageously, in order to enable communication between two mobile devices D1 and D2, the system of the invention requires a transfer rate of only 10 kbps to 20 kbps, preferably about 15 kbps, in order to be able to operate, and it is thus possible to attach a signal at a range of several hundreds of meters in order to communicate.

The carrier of the signal is linked to the quality of each mobile device.

The present invention is thus positioned ahead of conventional social networks, of the Facebook® type. It enables its own network to be created, by Wi-Fi and/or Bluetooth® type detection. With Wi-Fi pushing Bluetooth®, the range of Bluetooth® can be extended to several hundreds of meters.

Each user can determine settings for their account, either on the identification platform, or else via a conventional social network of the Facebook® type.

The system of the invention thus makes it possible to detect identified mobile devices that are nearby, even in the absence of a telephone network and/or a GPS signal. Such detected mobile devices can communicate so long as they are within the Wi-Fi and/or Bluetooth® fields. It is also possible for them merely to be listed when they are detected, and then to become available for communication when a telephone network becomes available or during synchronization.

Thus, e.g. during a train journey, the system of the invention makes it possible to list all of the identified mobile devices that have passed nearby during the journey. At the end of the journey, the user can thus see the profiles of each of those mobile devices and can communicate if so desired. Likewise, in a discotheque that is underground, where there is no telephone network and no GPS, the system of the invention makes it possible to detect all identified mobile devices and to communicate with them using Wi-Fi and/or Bluetooth. If users have given their addresses on Facebook® or the like, they can communicate subsequently in conventional manner via said social network. The present invention thus makes it easier to build and develop one's own network.

Advantageously, the system of invention is associated with a mobile application, which can be installed on any type of mobile device.

The present invention is described with reference to an advantageous embodiment, however it should be understood that a person skilled in the art can apply any modification without going beyond the ambit of the present invention as defined by the accompanying claims.

1. A detection and communication system for mobile devices, the system comprising at least two mobile devices of the mobile telephone, tablet, connected smartwatch, or similar type, each mobile device being equipped with long-range communication means of the Wi-Fi type and with short-range communication means of the Bluetooth® type, said system including an identification platform enabling users to identify their mobile devices, wherein said system detects all mobile devices identified on said identification platform and that come within the fields of said long-range and/or short-range communication means, and in that, in the absence of a telephone communication network, in particular of the 2G, 3G, 4G, 5G, UMTS, GPRS, or EDGE type, said long-range communication means push the signals of said short-range communication means so that two identified mobile devices within the fields of said long-range communication means can communicate via their short-range communication means, even beyond the range of said short-range communication means.

2. A system according to claim 1, wherein said identification platform is connected to at least one social network of the Facebook® type.

3. A system according to claim 1, wherein the Bluetooth is of type 1, 2, 3, or 4, in particular at the frequency of 2.4 GHz.

4. A system according to claim 1, wherein the Wi-Fi is based on the 802.11 standard at a frequency of 2.4 GHz to 5 GHz, and in particular in any of the A, B, G, N, AC, AD, AH forms.

5. A system according to claim 1, wherein Bluetooth® and Wi-Fi are added together for each mobile device, thereby creating an antenna specific to each mobile device.

6. A system according to claim 1, wherein the data transfer rate between mobile devices in communication is of the order of 10 kbps to 20 kbps, typically about 15 kbps.

7. A system according to claim 1, including a mobile application installed on each mobile device.
